(19) United States
(12) Patent Application Publication
(10) Pub. No.: US 2022/0372746 A1
(43) Pub. Date: Nov. 24, 2022

(54) SEWER CLEANOUT CAP AND METHODS

(71) Applicants: Matthew Treado, Marquette, MI (US); Brian Patrick Janowski, Marquette, MI (US)

(72) Inventors: Matthew Treado, Marquette, MI (US); Brian Patrick Janowski, Marquette, MI (US)

(21) Appl. No.: 17/748,010

(22) Filed: May 18, 2022

Related U.S. Application Data
(60) Provisional application No. 63/190,121, filed on May 18, 2021.

(51) Int. Cl. E03F 7/00

(52) U.S. Cl. CPC E03F 7/00

(57) ABSTRACT

Disclosed herein is a sewer cleanout cap that facilitates highly accurate and quick location of a buried or concealed cleanout cap using an electronic locator device. The cleanout cap comprises a circular cap body further comprising a proximal face and a distal face. A circular external radial wall extends between the proximal face and distal face with threads thereon. Extending from the proximal face is a drive block defined laterally by a series of lateral drive flats. The drive block terminates at a proximal drive block face. A first magnet is secured along a central axis on the sewer cleanout cap. In some embodiments the first magnet is secured within a recess within the cap body or drive block. In other embodiments, the first magnet is fixed to the proximal drive block face, a first recess face, or the distal face.

### CROSS REFERENCE TO RELATED APPLICATIONS

This application claims priority to Provisional Patent Application No. 63/109,121 filed May 18, 2021, the entire disclosure of which is hereby incorporated by reference and relied upon.

### BACKGROUND OF THE INVENTION

### Field of the Invention

The invention relates generally sewer cleanout caps, and more particularly to sewer cleanout caps that have properties making them easy to locate by sensing equipment.

### Description of Related Art

Attempts have been made by some to create a locatable sewer cleanout cap by duct taping a magnet on the outside of a sewer cap. This system often fails due to decomposition of the tape and the magnet falling away from the sewer cap. Panella (U.S. Pat. No. 5,038,829) teaches a sewer line clean out unit comprising a magnet in the upper surface of the cover at a perimeter edge as illustrated in FIG. 18 of Panella. Panella also discloses a magnet secured to an upper surface of a disc shaped cap where in the upper surface appears offset from a centralized drive surface. This offset placement results in inaccuracy when attempting to find the center drive axis of the sewer cleanout cap thus causing the user to typically dig a larger perimeter hole. Argonics® Corporation discloses on their website a sewer seal cleanout access cover made of polyurethane with a magnet embedded in the middle of the polyurethane cover. The cover is a press-in frictional design made of polyurethane directed primarily to vertically orientated sewer pipes. This cover lacks threads and has limited ability to seal non-vertical pipes. Removal of the cover is by use of a screw driver to wedge the cover out of the pipe similar to removing a cover to a paint can. The use of polyurethane is an expensive choice of material that is beyond the budgets of many users and can have varying stiffness depending on the ambient temperature.

What is needed is a low cost threaded sewer cleanout cap preferably made of a hard polymer that integrates a generally centrally located magnet on or within a drive block or cap body of the sewer cap.

### SUMMARY OF THE INVENTION

Disclosed herein are embodiments of a polymer sewer cleanout cap that integrates magnetic materials within the sewer cap near its central axis thereby assisting with locating sewer cleanouts.

In one form, a sewer cleanout cap comprises a disc shaped cap body.

In one form, the disc shaped cap body comprises a substantially flat proximal face that is accessible when in an operable configuration wherein the sewer cap is threaded into a sewer pipe. In a removed configuration, the sewer cap is removed from a sewer pipe.

In one form, the disc shaped cap body comprises a substantially flat distal face opposite the proximal face. The distal face faces the inside of the sewer pipe when threaded on the sewer pipe.

In one form, the disc shaped cap body comprises a circular external radial wall around a perimeter of the disc shaped cap body.

In one form, radial threads are inscribed in the external radial wall and operable for threaded cooperation with threads within a sewer pipe for sealing the sewer pipe using the sewer cleanout cap.

In one form, extending proximally from the cap body is a drive block operable for rotatably driving the sewer cleanout cap with a wrench.

In one form, the drive block comprises a drive block face spaced proximally from the proximal face.

In one form, a plurality of lateral drive flats extend between the proximal face and proximal drive block face.

In one form, the drive block comprises four lateral drive flats defining a substantially square drive block. In other forms, additional lateral drive flats can define drive blocks of other shapes such as hexagonal.

In one form, the distal face is substantially flat extending across to all ends of the external radial wall.

In one form, a first recess extends from the distal face at least partially into the cap body.

In one form, the first recess is defined by a first radial wall spaced inward from the external radial wall.

In one form, the first radial wall defines a circle.

In one form, a first recess face is inset proximally from the distal face.

In one form, the first recess face and the first radial wall define the first recess.

In one form, a second recess extends proximally from at least one of the distal face and first recess face at least partially into said drive block.

In one form, the second recess comprises a second radial wall spaced inward from the lateral drive flats.

In one form, the second recess is substantially square although it can be defined by other profiles such as hexagonal.

In one form, the second recess terminates at a second recess face.

In one form, the second recess is defined by the plurality of second radial walls and second recess face.

In one form, a sewer cap comprises a first magnet.

In one form, the first magnet comprises a substantially flat first magnet face.

In one form, the first magnet comprises a substantially flat third magnet face opposite the first magnet face.

In one form, the first magnet comprises a radial second magnet face extending between the first magnet face and third magnet face.

In one form, a first magnet recess is defined by one or more magnet recess faces extending into the drive block.

In one form, a first magnet recess extends distally from the proximal drive block face.

In one form, a first magnet recess extends laterally from a lateral drive flat into the drive block.

In one form, the first magnet recess comprises at least one of a: first recess retainer, a second recess retainer, and a third recess retainer.

In one form, the recess retainers partially obstruct the first magnet recess.

In one form, the recess retainers are spaced about the opening to the first magnet recess.

In one form, the first magnet is seated in the first magnet recess.

In one form, the first magnet is sized and shaped for friction fit into the first magnet recess.

In one form, the first magnet is secured in the first magnet recess by the recess retainers.

In one form, the first magnet is molded within the drive block during forming of the sewer cap of a polymer such as PVC, polypropylene, CPVC, and ABS.

In one form, a first magnet is secured to the cap body by one or more of adhesives such as epoxy, glue, and tape.

In one form, a first magnet is secured to the second recess face.

In one form, the first magnet is secured substantially aligned with central axis A.

In one form, the sewer cap is absent a first recess and a second recess.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1A depicts an exploded perspective view of the sewer cleanout cap of FIG. 1B;

FIG. 1B depicts a perspective view of a sewer cleanout cap;

FIG. 1C depicts an opposed perspective view of the sewer cleanout cap of FIG. 1B;

FIG. 2A depicts an exploded perspective view of the sewer cleanout cap of FIG. 2B;

FIG. 2B depicts a perspective view of a sewer cleanout cap;

FIG. 3A depicts an exploded perspective view of the sewer cleanout cap of FIG. 3B;

FIG. 3B depicts a perspective view of a sewer cleanout cap;

FIG. 4A depicts a cross-sectional perspective view of the sewer cleanout cap of FIG. 4B;

FIG. 4B depicts a perspective view of a sewer cleanout cap;

FIG. 5 depicts a perspective view of a sewer cleanout cap;

FIG. 6A depicts an exploded perspective view of the sewer cleanout cap of FIG. 6B;

FIG. 6B depicts a perspective view of a sewer cleanout cap;

FIG. 7A depicts an exploded perspective view of the sewer cleanout cap of FIG. 7B;

FIG. 7B depicts a perspective view of a sewer cleanout cap;

FIG. 7C depicts a cross-sectional perspective view of the sewer cleanout cap of FIG. 7B.

FIG. 8 depicts a perspective view of a sewer cleanout cap;

FIG. 9 depicts a perspective view of a sewer cleanout cap.

### DETAILED DESCRIPTION OF SELECTED EMBODIMENTS OF THE INVENTION

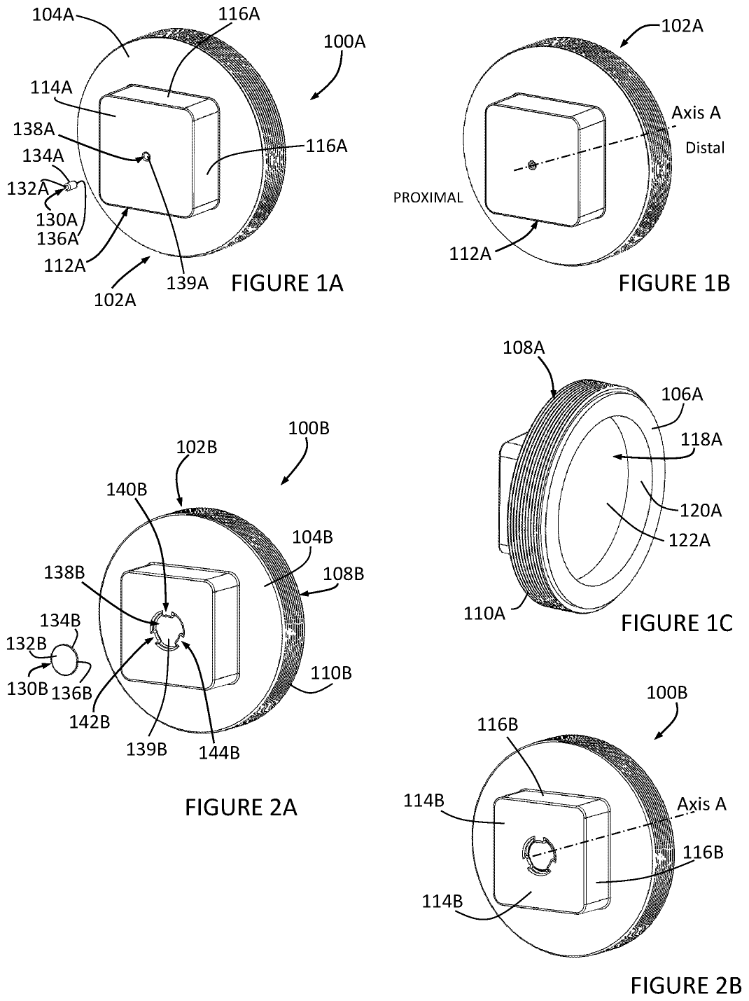

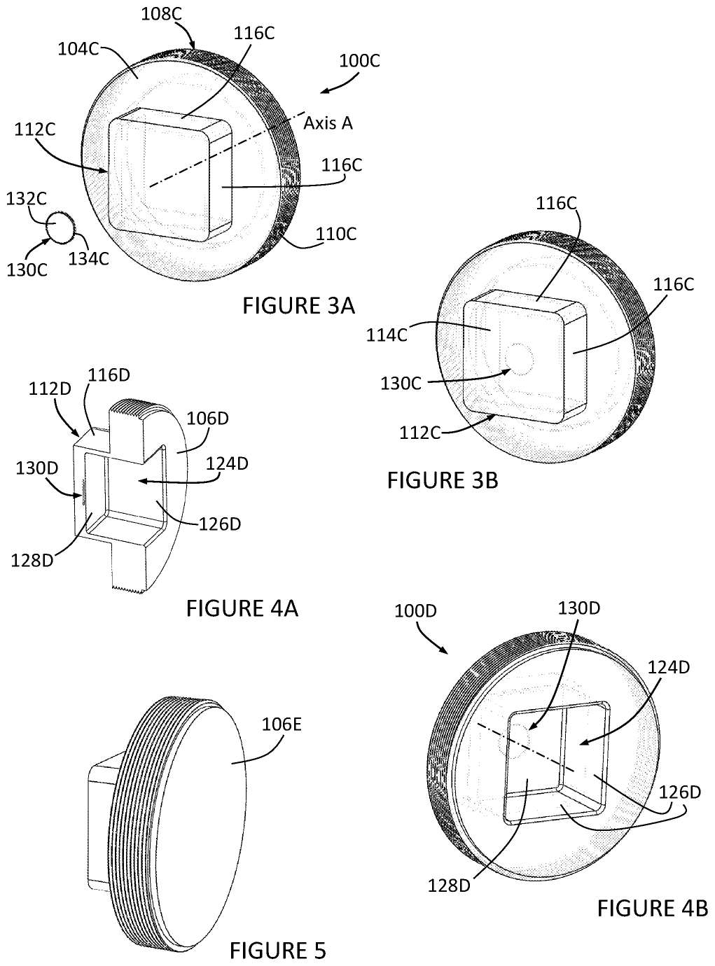

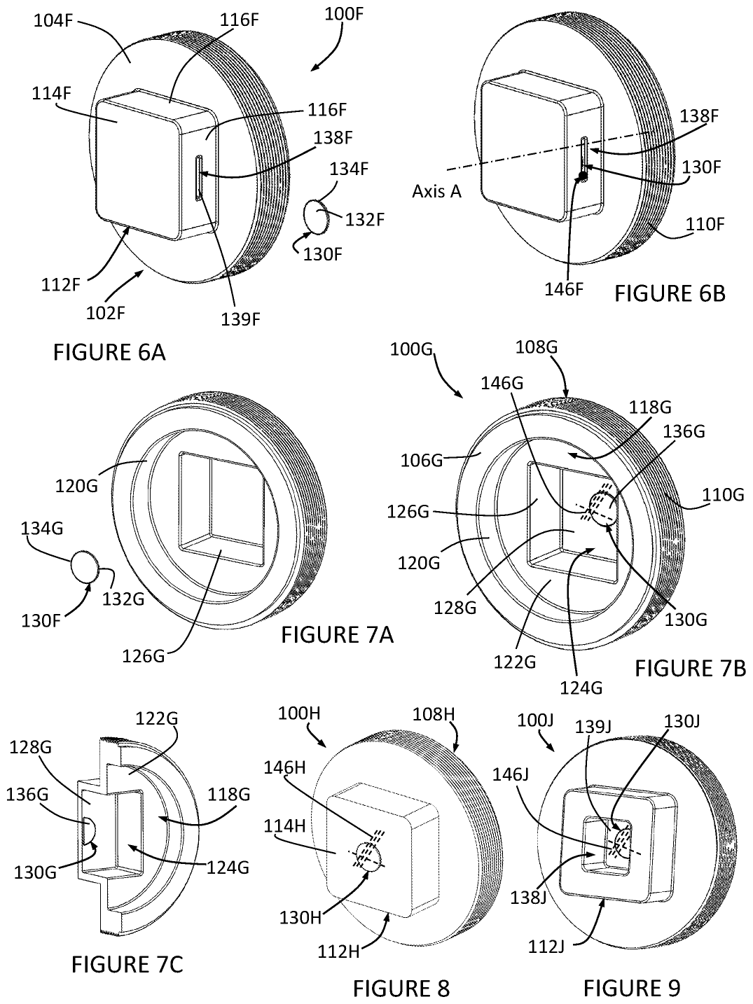

Select embodiments of the invention will now be described with reference to the Figures. Like numerals indicate like or corresponding elements throughout the several views and wherein various embodiments are separated by letters (i.e. 100A, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes, or which is essential to practicing the invention described herein. Some of the views illustrated are exploded views whereby: FIG. 1A is an exploded view of FIG. 1B, FIG. 2A is an exploded view of FIG. 2B, FIG. 3A is an exploded view of FIG. 3B, FIG. 6A is an exploded view of FIG. 6B, and FIG. 7A is an exploded view of FIG. 7B.

FIG. 1A-1C illustrates a sewer cleanout cap according to one embodiment of the invention. The sewer cleanout cap 100A comprises a disc shaped cap body 102A. The disc shaped cap body 102A comprises a proximal face 104A that is accessible when in an operable configuration wherein the sewer cleanout cap is threaded into a sewer pipe, and a distal face 106A opposite the proximal face. In most embodiments, the proximal and distal faces are substantially flat, however, those skilled in the art will recognize other non-flat configurations such as a sloped face or faceted face can be assumed. The distal face faces the inside of the sewer pipe when threaded on a sewer pipe. As illustrated here, the cap body 102A comprises a circular external radial wall 108A extending around a perimeter of the cap body with radial threads inscribed in the external radial wall 108A and operable for threaded cooperation with threads within a sewer pipe for sealing the sewer pipe using the sewer cleanout cap. In some forms the cap is substantially a hard plastic such as PVC, ABS or other similar material known in the art.

Extending proximally from the cap body 102A is a drive block 112A operable for rotatably driving the sewer cleanout cap 100A with a wrench. The drive block 112A comprises a drive block face 114A generally parallel and spaced proximally from the proximal face. A plurality of lateral drive flats 116A extend between the proximal face 104A and proximal drive block face 114A. The drive block 112A comprises four lateral drive flats 116A defining a substantially square drive block, however, in other embodiments, more lateral drive flats may be present defining a hex drive block for example.

The distal face 106A is spaced distally from the proximal face 104A and is substantially flat extending across to the external radial wall 108A. In this embodiment, although optional in some embodiments, a first recess 118A extends from the distal face 106A at least partially into the cap body 102A. The first recess 118A is defined by a first radial wall 120A spaced inward from the external radial wall 108A. A first recess face 122A is inset proximally from the distal face 106A. Together, the first recess face 122A and the first radial wall 120A define the first recess 118A.

In other embodiments such as illustrated in FIG. 4B and sectional view of FIG. 4A and although optional, a second recess 124D extends proximally from at least one of the distal face 106D and first recess face (i.e. 122G) at least partially into said drive block 112D. As further illustrated in FIG. 4B, the second recess 124D comprises second radial walls 126D spaced inward towards central axis A from the lateral drive flats 116D. As illustrated here, the second recess 124D terminates at a second recess face 128D. The second recess 124D is defined by the plurality of second radial walls 126D and second recess face 128D. In some embodiments, the sewer cleanout caps disclosed herein can be absent a first recess and/or a second recess as illustrated in the embodiment of FIG. 5. (In FIG. 5 the first magnet is molded into the drive block).

Each embodiment of a sewer cleanout cap further comprises a first magnet. Although the first magnet can assume any variety of shapes, most commonly the first magnet 130A comprises a substantially flat first magnet face 132A and a substantially flat third magnet face 136A opposite the first magnet face. A radial second magnet face 134A extends between the first magnet face 132A and third magnet face 136A. Some examples of various magnets are illustrated in the figures such as 130A in FIG. 1A, and 130B in FIG. 2A. One skilled in the art will recognize that the first magnet can assume a variety of profiles as can the first magnet recess where it is seated. For example, the magnet can have a second magnet face that is non-circular such as square or hexagonal shape.

A first magnet recess 138A is defined by one or more magnet recess faces 139A. In the FIG. 1A embodiment, the first magnet 130A recess extends distally from the proximal drive block face 114A into the drive block 112A. As illustrated in other embodiments such as FIG. 6A, the first magnet recess 138F extends laterally from a lateral drive flat 116F into the drive block 112F. The first magnet recess in alternative embodiments can be recessed into the second recess face such as illustrated with 128D.

As illustrated in the FIG. 2A-2B embodiment, the first magnet recess comprises at least one of a: first recess retainer 140B, a second recess retainer 142B, and a third recess retainer 144B whereby the recess retainers partially obstruct the first magnet recess 138B. As seen here, in an operable configuration, the first magnet 130B is seated in the first magnet recess 138B and the first magnet 130B is sized and shaped for seating within the first magnet recess 138B (i.e. circular magnet in circular recess) and held in position with one or more recess retainer. In other embodiments such as illustrated in FIG. 1A, the first magnet 130A is operable for friction fit into first magnet recess 138. Alternatively, the first magnet can be fixed by using a bonding material such as an epoxy or other adhesive/bonding agent which can be in contact with one or more surfaces of the first magnet. As recognized by those skilled in the art, individual features illustrated in the Figures can be combined in unique combinations for sewer cleanout caps consistent with the intentions of this disclosure.

As illustrated in the FIGS. 3A and 3B embodiment, the first magnet 130C is molded within the drive block 112C during forming operations of the sewer cap of a polymer such as PVC. In one form, a first magnet is secured to or blocked from release from the cap body by one or more of adhesives such as epoxy, glue, and tape. An example is illustrated in FIG. 6B whereby adhesive 146F blocks first magnet 130F from escaping the first magnet recess 138F. Similarly, as shown in FIG. 7B, an adhesive 146G can be used to bond the first magnet to a surface of the sewer cleanout cap or otherwise bury the first magnet within the adhesive. Here, the first magnet 130G is secured to the second recess face 128G. Similar to the embodiment of FIG. 7B, in alternative embodiments, an adhesive can be used to block first magnet 130B in first magnet recess 138B in the absence of the recess retainers or to adhere a first magnet 130H to the proximal drive block face 114H (preferably along axis A) in the absence of a first magnet recess such as illustrated in FIG. 8. FIG. 9 illustrates a first magnet 130J secured to a magnet recess face 139J in a first magnet recess 138J that is oversized and/or having a different profile than the first magnet (i.e. a square first magnet recess and round first magnet). Again, an adhesive 146J can be used to secure the first magnet 130J generally at the central axis.

Note in preferred embodiments, the first magnet is substantially aligned with central axis A extending central through the cap body. This positioning creates more accurate finding missions and therefore reduced digging to find the sewer cleanout cap when buried under dirt in a yard. Reduced digging of course equates to reduced labor costs.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. (canceled)

2. (canceled)

3. A sewer cleanout cap comprising:
a cap body;
said cap body being substantially disc shaped;
said cap body having a proximal face that is accessible when said sewer cleanout cap is in an operable configuration threaded into a sewer pipe;
said cap body having a distal face spaced distally from said proximal face;
said cap body having an external radial wall extending between said distal face and said proximal face;
said external radial wall inscribed about its perimeter with radial threads operable for mating with a sewer pipe;
a drive block;
said drive block extending from said proximal face;
said drive block having a drive block face spaced proximally from said proximal face;
said drive block comprising four lateral drive flats extending perpendicular to said proximal face and extending between said proximal face and said drive block face;
said drive block and said cap body aligned along a common central axis;
a first magnet;
said first magnet fixed to said sewer cleanout cap;
said first magnet aligned with said central axis.

4. The sewer cleanout cap of claim 3 further comprising:
a magnet recess face;
said magnet recess face defining a first magnet recess extending into said drive block;
said first magnet disposed in said first magnet recess.

5. The sewer cleanout cap of claim 4 whereas said first magnet recess is substantially cylindrical.

6. The sewer cleanout cap of claim 3 further comprising:
at least one of a first magnet retainer, a second magnet retainer, and a third magnet retainer operable to secure said first magnet in said first magnet recess.

7. The sewer cleanout cap of claim 3 further comprising:
a first recess face spaced proximally in said cap body from said distal face;
a first radial wall inset from said external radial wall;
said first radial wall extending between said distal face to said first recess face;
and
whereas said first radial wall and said first recess face define a first recess extending into said distal face.

8. The sewer cleanout cap of claim 3 further comprising:
a second recess face spaced distally in said drive block from said proximal drive block face;
a second radial wall inset from said lateral drive flats;
said second radial wall extending from said second recess face to at least a first recess face wherein said first recess face is positioned between said distal face and said proximal face; and
whereas said second radial wall and said second recess face define a second recess extending into said drive block.

9. The sewer cleanout cap of claim 3 whereby said cap body is absent a first or second recess extending through said distal face.

10. The sewer cleanout cap of claim 3 whereby said first magnet is bonded to said drive block face.

11. The sewer cleanout cap of claim 8 whereby said first magnet is bonded to said second recess face.

12. The sewer cleanout cap of claim 3 further comprising:
a first magnet recess;
said first magnet recess entending medially from one of said lateral drive flats into said drive block; and
said first magnet secured within said first magnet recess at a central axis of said cap body.

13. The sewer cleanout cap of claim 3 further comprising a second recess extending through said distal face into said sewer cleanout cap whereas said second recess is inset from both said lateral drive flats and said external radial wall.

14. The sewer cleanout cap of claim 3 further comprising:
a first recess or a second recess, or a first recess and a second recess;
said first recess and said second recess extending through said distal face;
whereas a first radial wall of said first recess is inset from said external radial wall; and
whereas a second radial wall of said second recess is inset from said lateral drive flats.

15. The sewer cleanout cap of claim 3 whereas said first magnet has a disc shaped profile.

16. The sewer cleanout cap of claim 3 whereas said first magnet has a cylindrical profile.

17. The sewer cleanout cap of claim 3 whereas said first magnet has a non-circular profile.

18. The sewer cleanout cap of claim 3 whereas said first magnet is molded within said drive block.

19. The sewer cleanout cap of claim 3 whereas said first magnet is secured and substantially aligned with a central axis extending through said cap body.

20. The sewer cleanout cap of claim 3 further comprising:
a magnet recess;
a first recess;
said first recess extending from said distal face into said cap body toward said proximal face and terminating at a first recess face;
whereas said magnet recess extends proximally from at least one of said distal face and said first recess face at least partially into said drive block.

21. The sewer cleanout cap of claim 3 further comprising:
a first magnet recess;
one or more recess retainers;
whereby said recess retainers obstruct a portion of said first magnet recess thereby securing said first magnet therein.

22. The sewer cleanout cap of claim 3 further comprising a first magnet recess formed within said sewer cleanout cap; and
whereas said first magnet is secured in said first magnet recess by friction fit.
